(19) United States
(12) Patent Application Publication
(10) Pub. No.: US 2025/0371468 A1
(43) Pub. Date: Dec. 4, 2025

(54) SYSTEM AND METHOD FOR IMPROVING THE EFFICIENCY AND SECURITY OF ELECTION VOTING

(71) Applicant: Anthony Saadey, Lewis Center, OH (US)

(72) Inventor: Anthony Saadey, Lewis Center, OH (US)

(21) Appl. No.: 18/670,087

(22) Filed: May 21, 2024

(51) Int. Cl. G06Q 10/0633; G06F 21/62; G06K 7/10; G07C 13/00

(52) U.S. Cl. CPC G06Q 10/0633; G06F 21/6218; G06K 7/10366; G07C 13/00; G06Q 2230/00

(57) ABSTRACT

A system and method for improving the efficiency and security of election voting. The disclosure includes packages of ballot paper with unique identification tags, ballot transport containers with unique identification tags, a means of reading the identification tags, a means of sending the information from reading the identification tags to a software application, and a software application. The software application is configured with various interfaces to record election data, track ballot custody changes, and assist election officials in drafting election materials more efficiently.

### CROSS-REFERENCE TO RELATED APPLICATIONS

### STATEMENT REGARDING FEDERALLY SPONSORED RESEARCH OR DEVELOPMENT (IF APPLICABLE)

N/A

### BACKGROUND OF THE INVENTION

This invention addresses the problem of inefficient and unsecure election administration. The current methods for election administration are cumbersome and inefficient. Various administrative steps, such as ballot paper transport logistics, are decentralized and inefficient. Chain-of-custody records are produced and updated by hand. These manual entries consume immense amounts of time, result in repeated processes, and result in difficult auditing measures when voting results are disputed.

The current options available in the prior art are electronic voting systems and applying ID tags to individual ballots. Applying ID tags to individual ballots potentially removes the anonymity of how one votes. This does not provide extra security measures and further fails to increase the efficiency of current election systems.

### BRIEF SUMMARY OF THE INVENTION

This invention is a system and method for improving voting security and efficiency. The invention generally consists of a software application, various unique identification tags that track election logistic information, a means of reading the identification tags, and a means of integrating the information read from the ID tags with the software application.

The software application provides election administration officials a means to securely track and maintain historic election data. This allows officials to save time in pre-election preparation by providing estimates of ballot quantities, previous polling locations, and ballot forms that complied with prior administrative regulations. This provides officials immense time savings when preparing for new elections.

The ID tags allow for useful information to be recorded at various stages of the election process. This ongoing data collection facilitates the use of historic data for future efficiencies and provides a secondary verification of voting security and legitimacy. By implementing ID tags at the point of ballot production, ballots can be tracked at all times throughout the election.

The disclosed system utilizes a novel method of tracking ballots: assigning the ballot package to a polling location. Said ballot package is assigned a unique ID tag, facilitating electronic verification of the assigned contents. This allows for the electronic auditing of large quantities of ballots simply by scanning the ID tag of a ballot package.

The system also improves the efficiency of maintaining chain-of-custody logs. Chain-of-custody logs are a required component of election security. These logs are currently created and updated manually. However, the software application of the present disclosure compiles data tracked from the ID tags and formats the data into producible chain-of-custody logs. This may reduce, or even eliminate, the need for most manual entries involved in maintaining election chain-of-custody logs.

### BRIEF DESCRIPTION OF THE SEVERAL VIEWS OF THE DRAWINGS

The disclosure will be better understood and objects other than those set forth above will become apparent when consideration is given to the following detailed description thereof. Such description refers to the annexed drawings wherein:

FIGS. 1-4 are fragmentary diagrammatic plan views of an embodiment of the ballot creation and management interface of the software application.

FIG. 5 is a diagrammatic plan view of an embodiment of an embodiment of the software application's home interface.

FIG. 6 is a diagrammatic plan view of an embodiment of an interface of the software application for viewing event history.

FIGS. 7-17 are fragmentary diagrammatic plan views of an embodiment of the software application's interface for management and association of election supplies.

FIGS. 18-20 are fragmentary diagrammatic plan views of an embodiment of the software application's interface for creation, management, and association of polling locations.

FIGS. 21A-21C are fragmentary diagrammatic flow charts of the disclosed system and method.

### DETAILED DESCRIPTION OF THE INVENTION

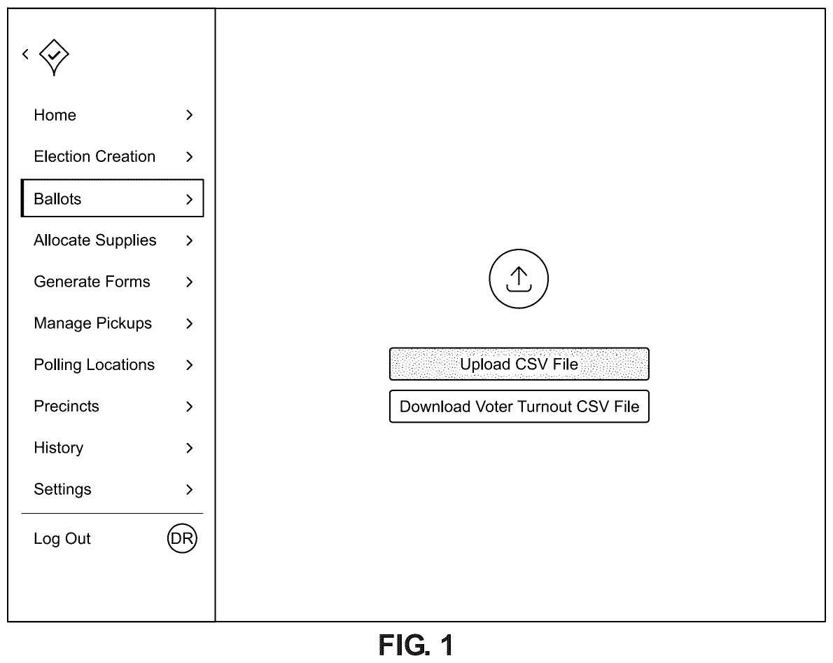

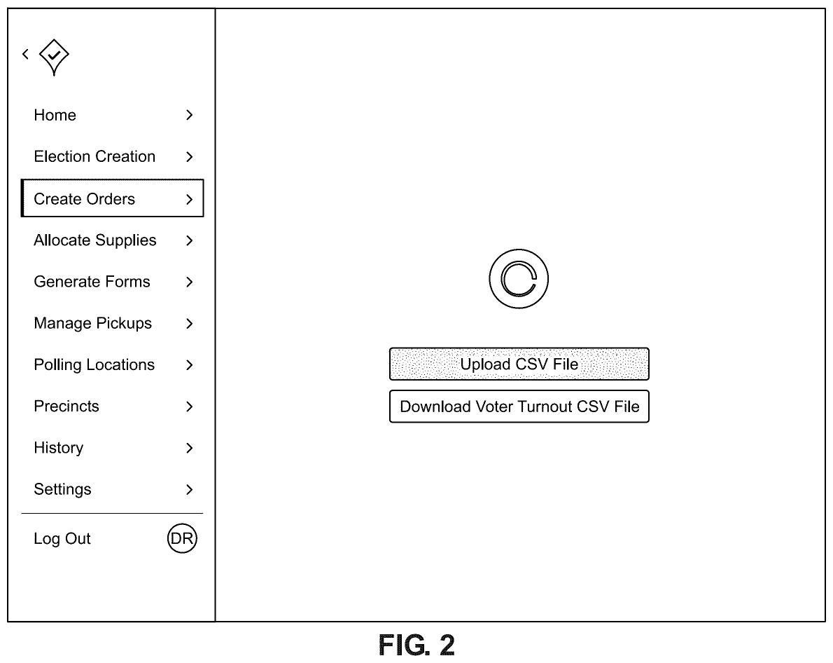

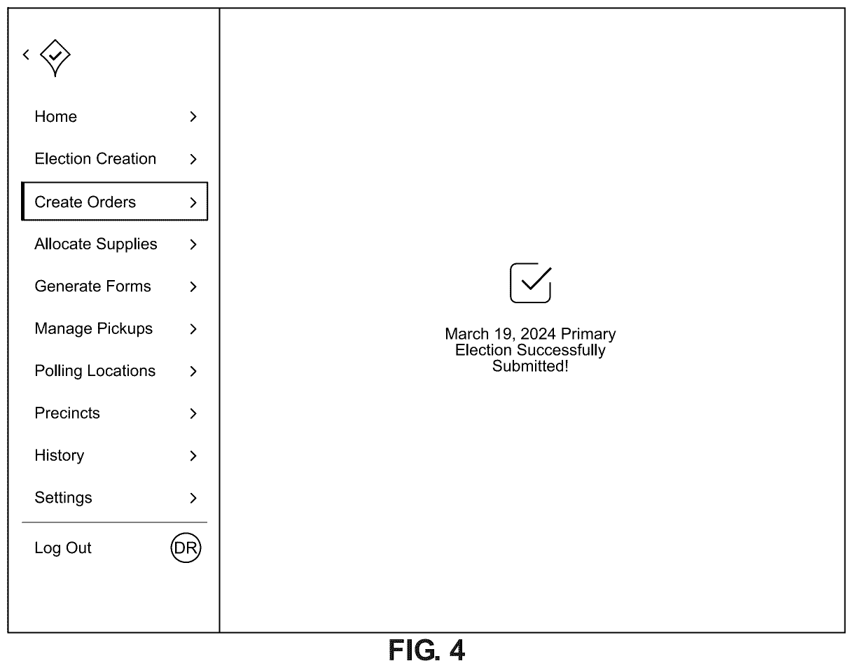

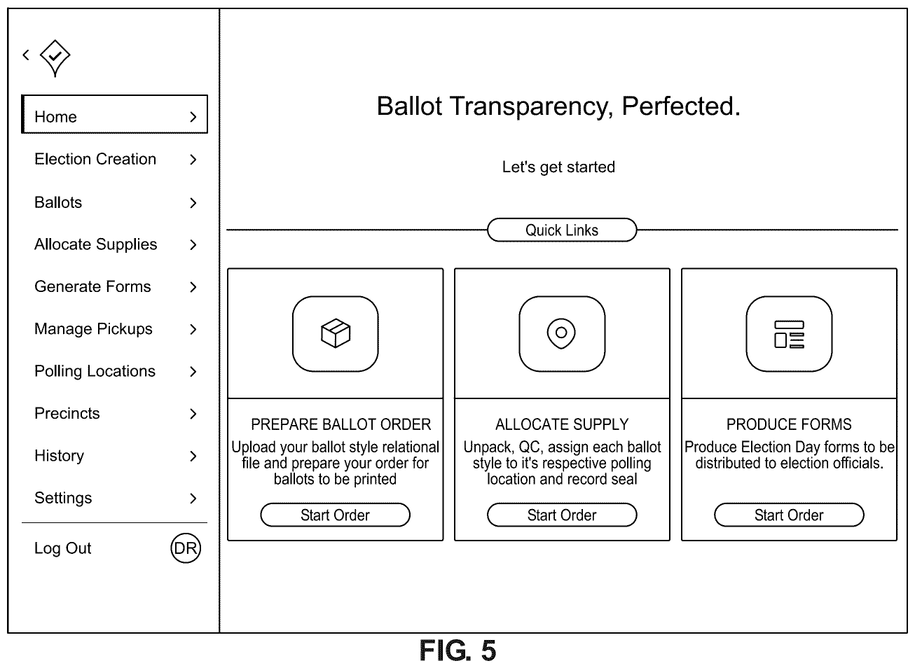

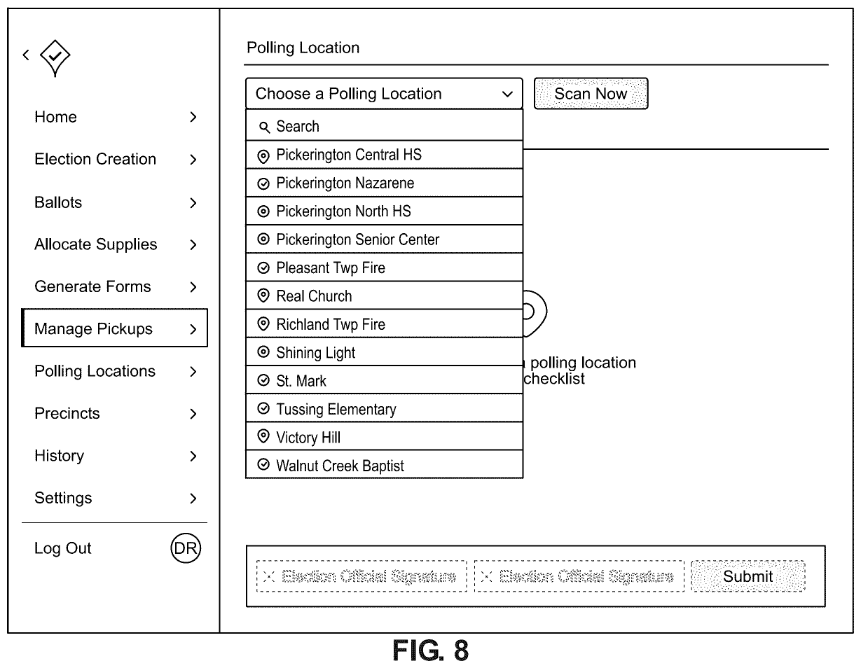

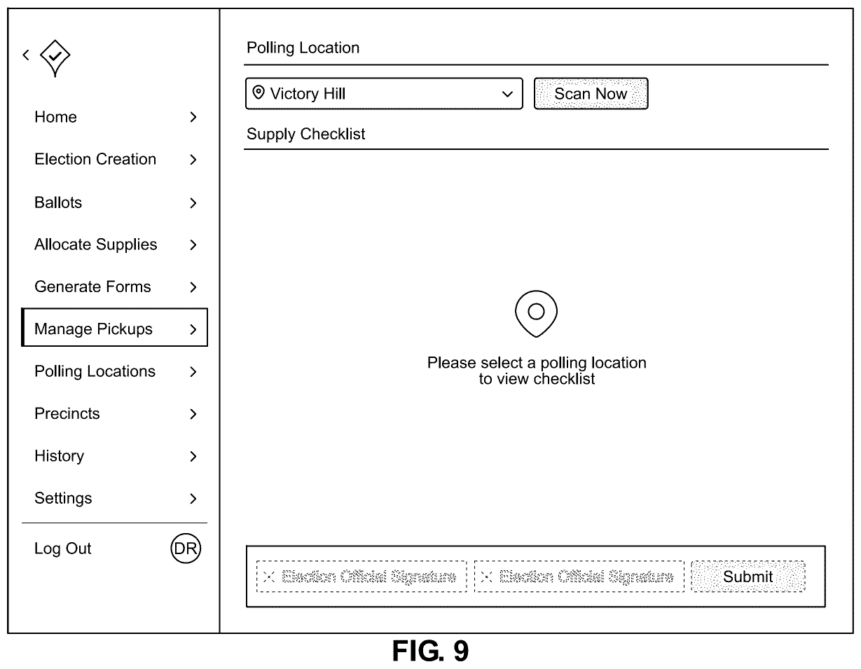

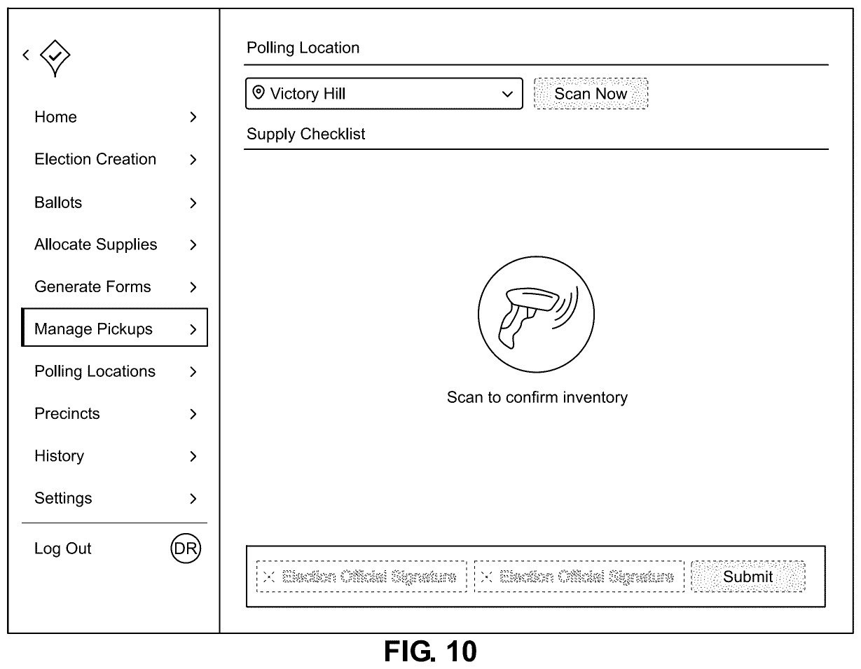

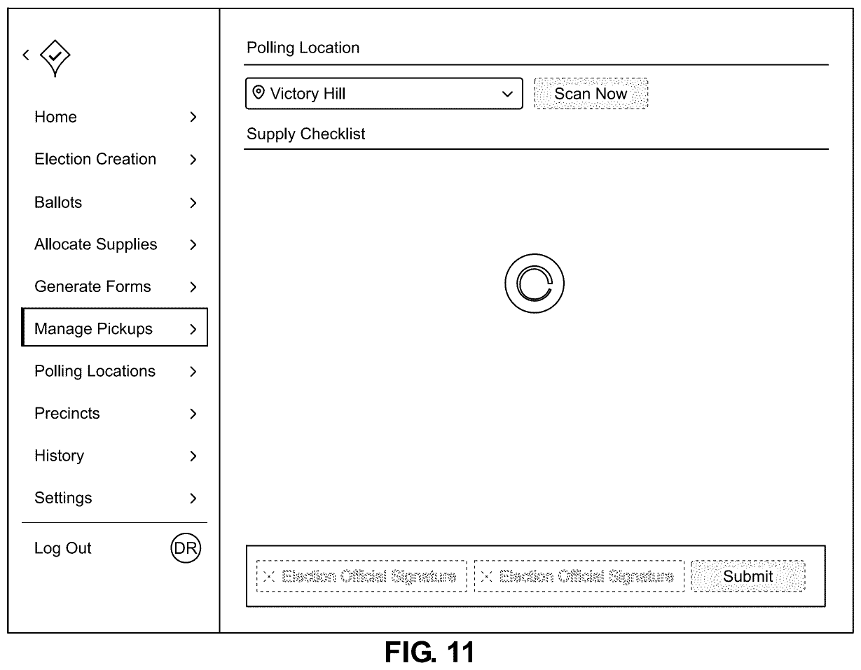

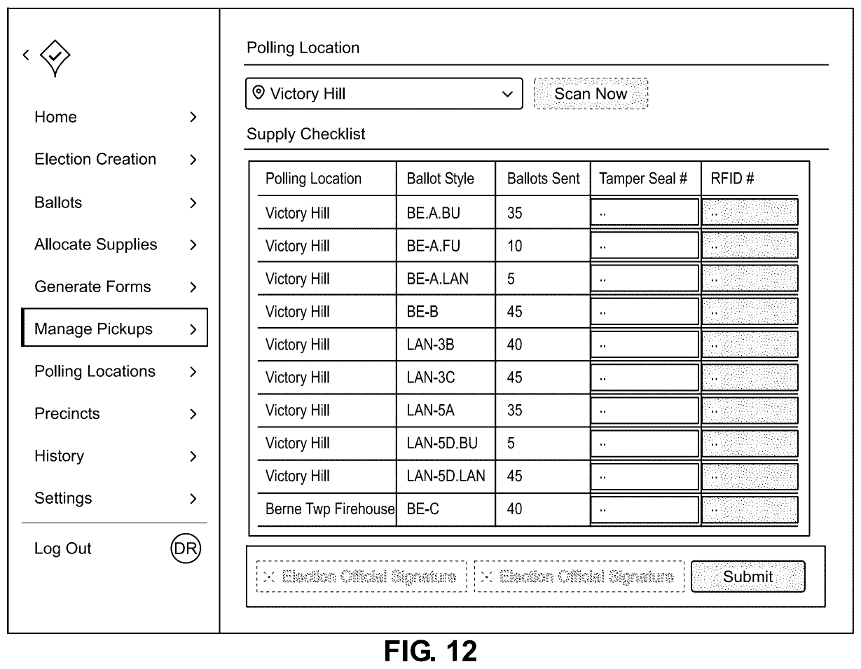

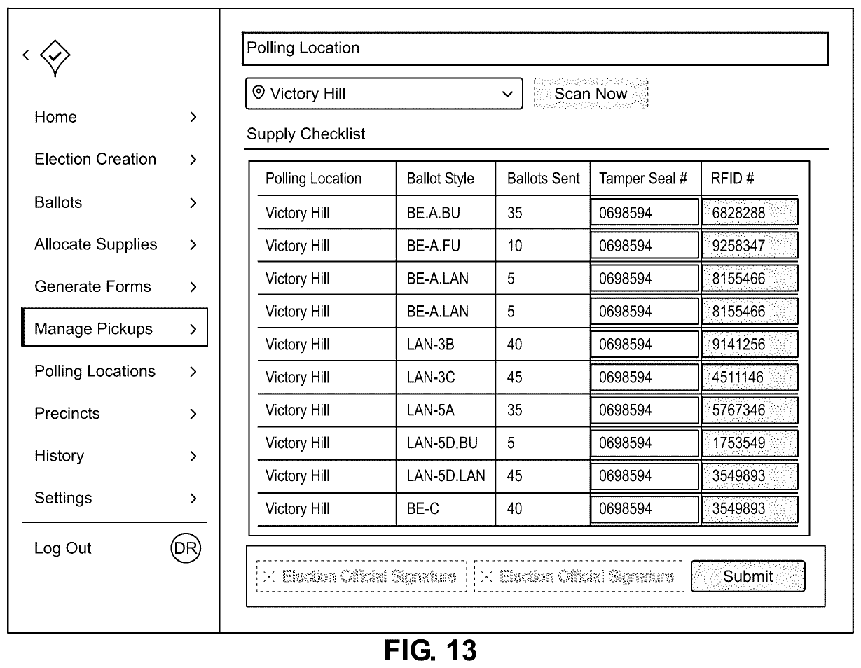

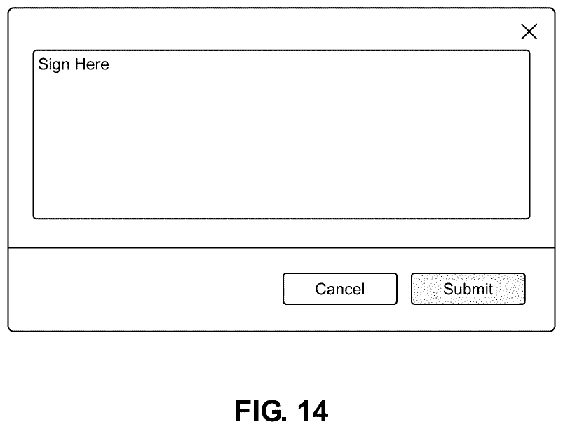

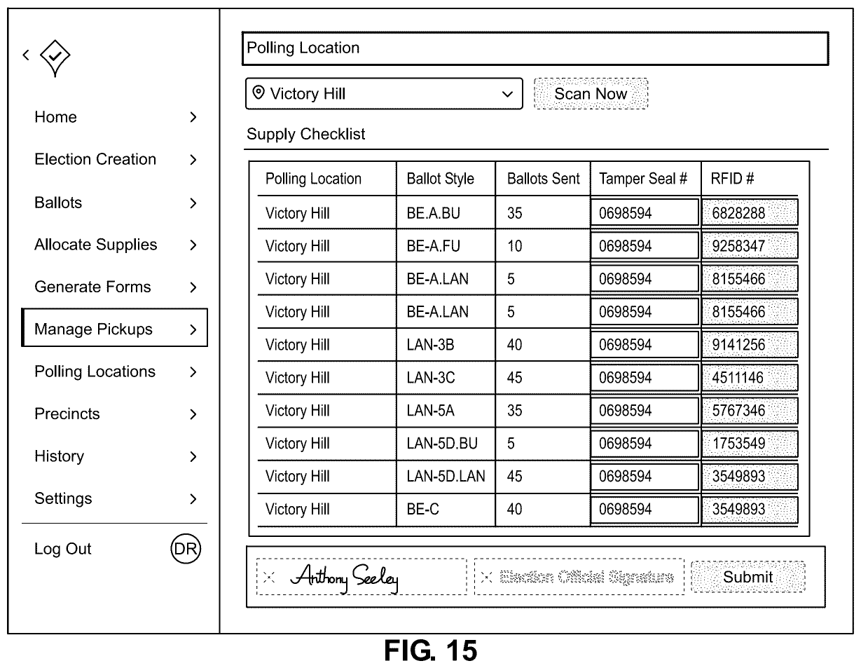

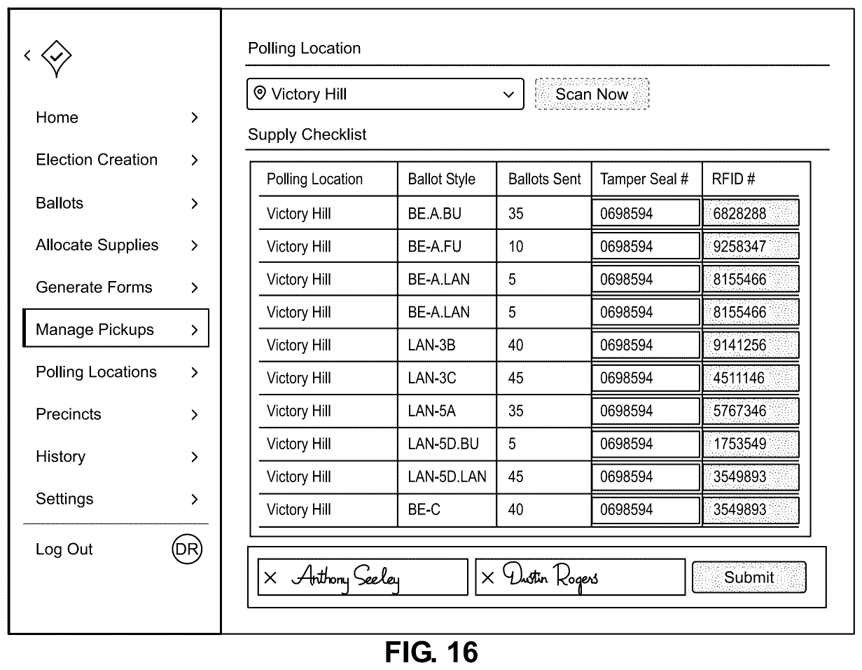

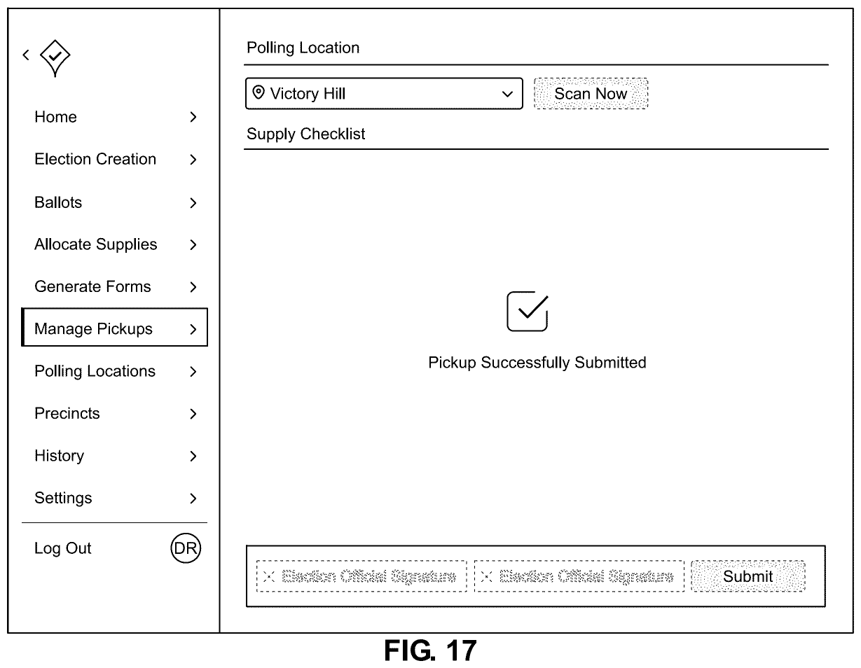

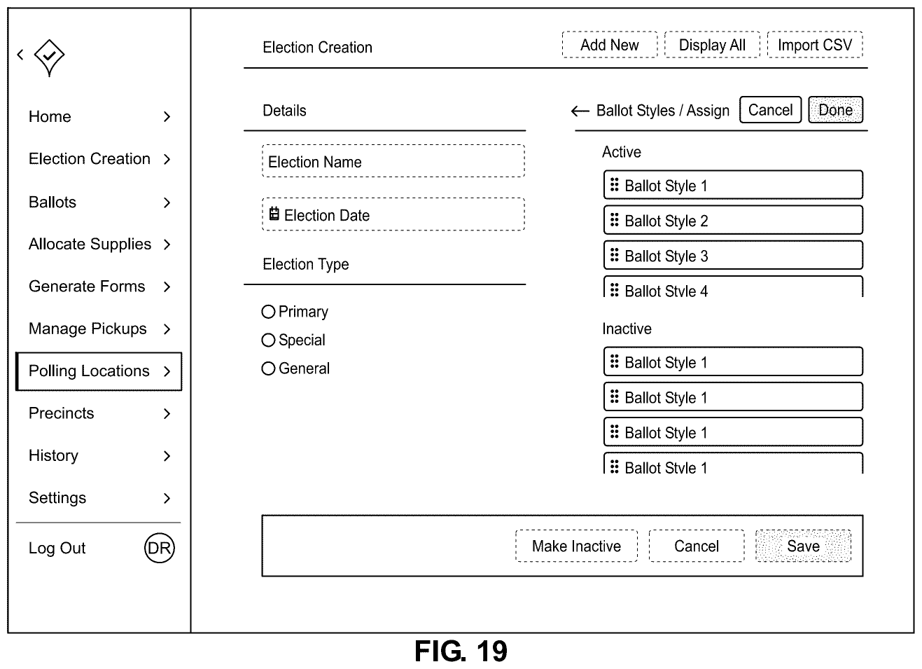

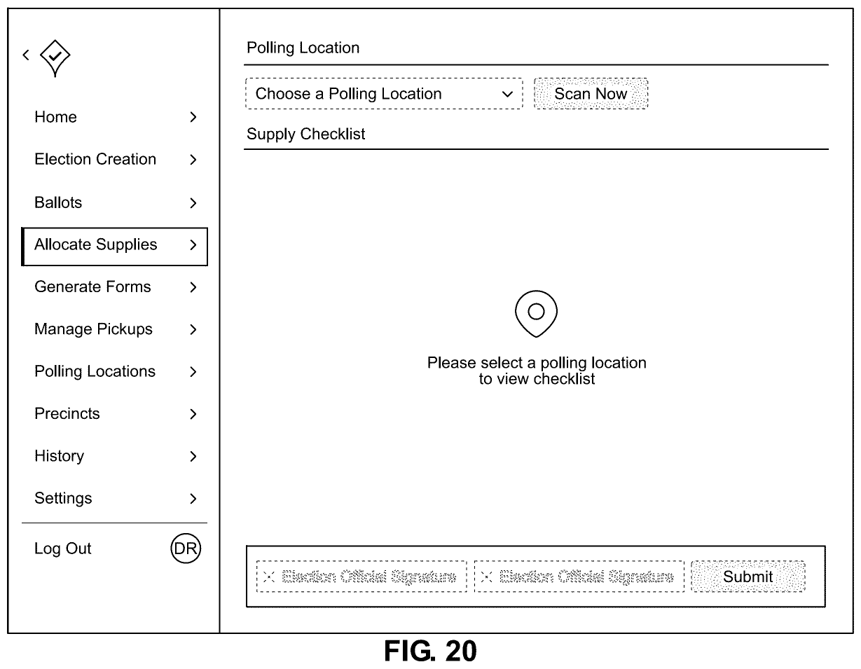

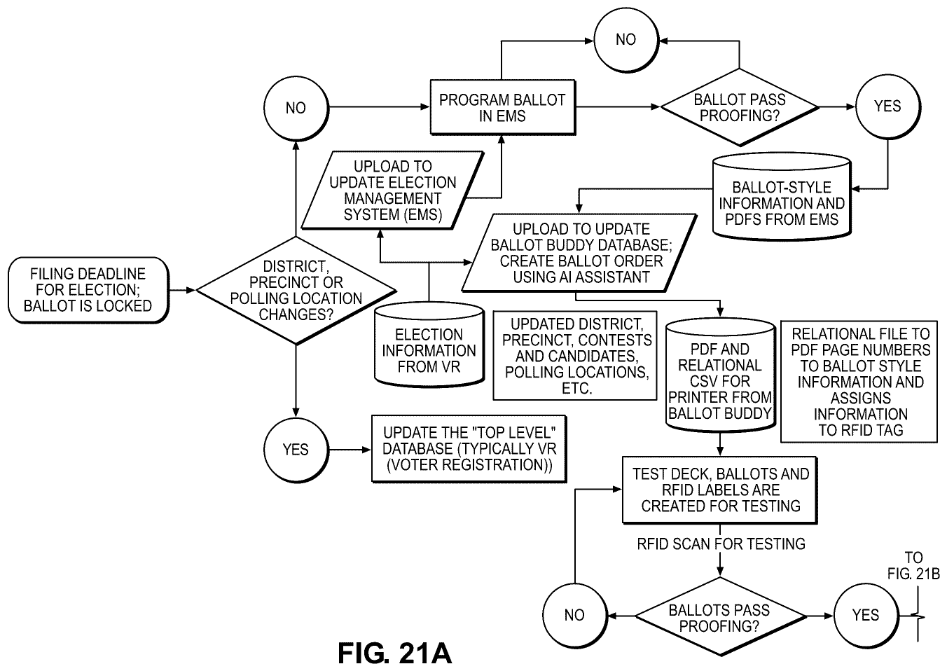

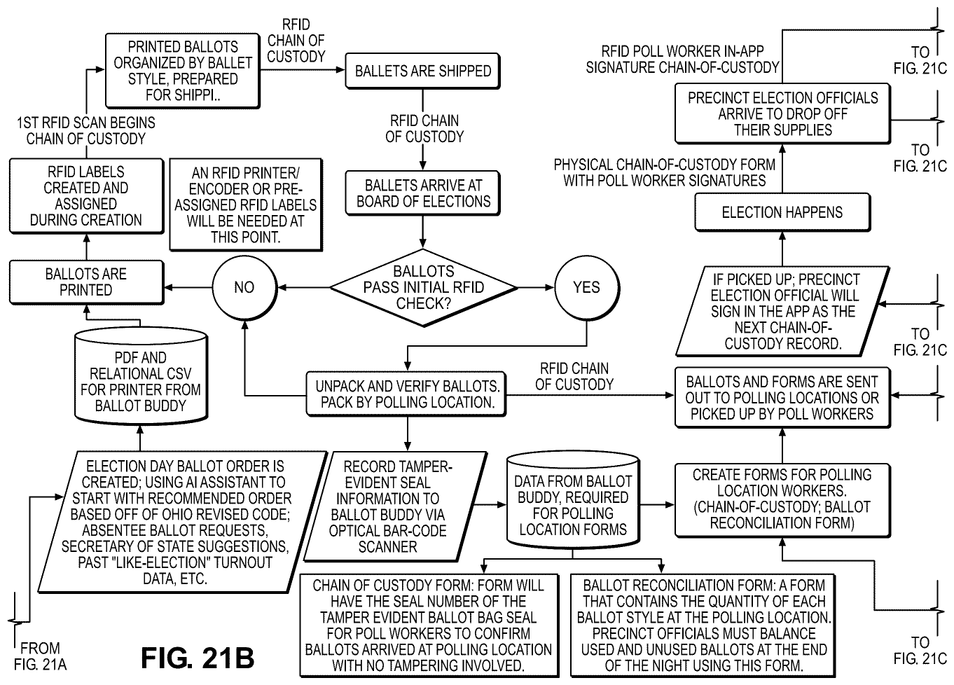

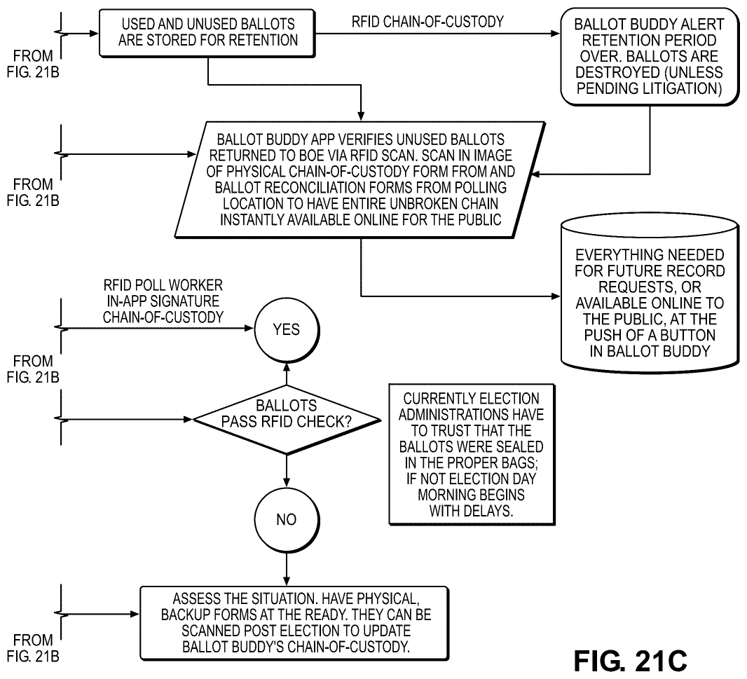

Referring now to FIGS. 1-20 of the drawings simultaneously, there is shown a preferred embodiment of the present invention being a system and method for improving the efficiency and security of elections. The system and method generally comprise a software application, ballot packages, containers for transporting election materials, a means for electronically reading information, and a means for electronically transmitting information to the software application.

Said software application comprises an interface for creation and management of a new election; an interface for creation and management of ballot styles for an election; an interface for creation, management, and association of polling locations for an election; an interface for management and association of supplies for an election; an interface for management and association of precincts for an election; an interface to view and manage the transfer of election supplies and materials; and an interface to view the history and details of each election tracked by the application.

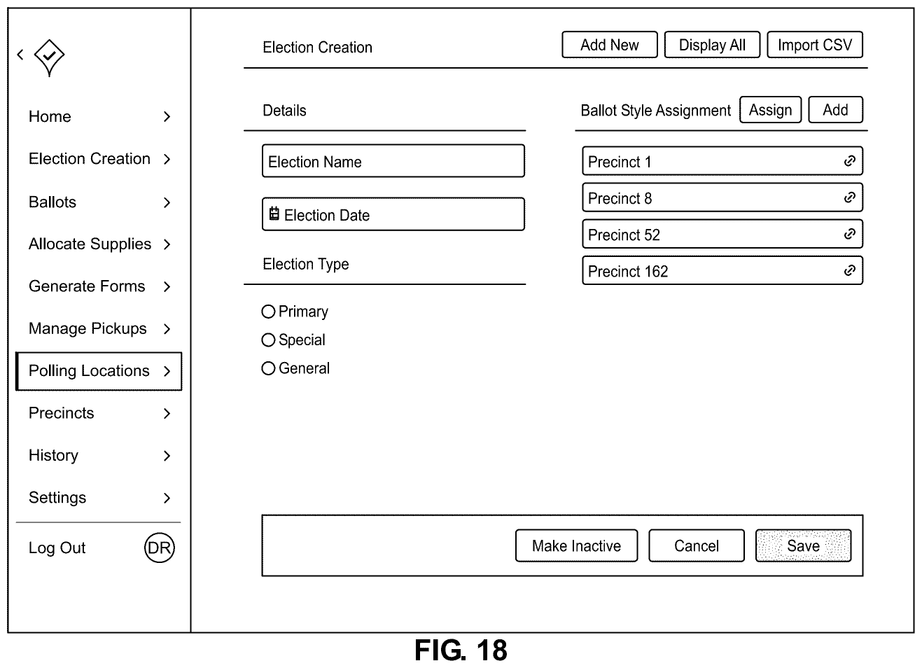

Said user interface for creation and management of an election consists of a series of text fields that provide identifying information about an election. Referring now to FIGS. 18-20, a preferred embodiment of said interface is shown for creation and management of an election. Said interface provides text fields for the name of the election, the date the election will take place, the type of election (e.g. primary, special, general), and precincts associated with the election.

A further embodiment of the election creation interface allows a user to upload a CSV file. The interface will read the uploaded file and automatically generate information fields relating to the creation of a new election.

Referring now to FIGS. 1-4, said interface for creation and management of ballot styles consists of a series of text fields used to create ballot styles, a series of fields used to create and track unique ID numbers, and a series of fields used to order quantities of ballot paper to be sent to specific polling locations. The ballot style text fields may be created manually by a user, or automatically generated by a user by uploading a CSV file, as depicted in the preferred embodiment illustrated by FIG. 1. The CSV file will be read by the application and used to automatically generate the ballot style fields relating to the election. The unique tracking ID numbers may be automatically generated by the application or manually created by a user. Each ID number must be unique and not a duplicate of any other tracking number used in a current or prior election. The order fields may be filled out manually by a user or automatically based on historic data tracked by the application. The order fields include fields for the total number of ballots to be sent to an associated polling location, the ballot style to be used in production of the ballot paper, and the associated polling location to receive the specific quantity of ballots.

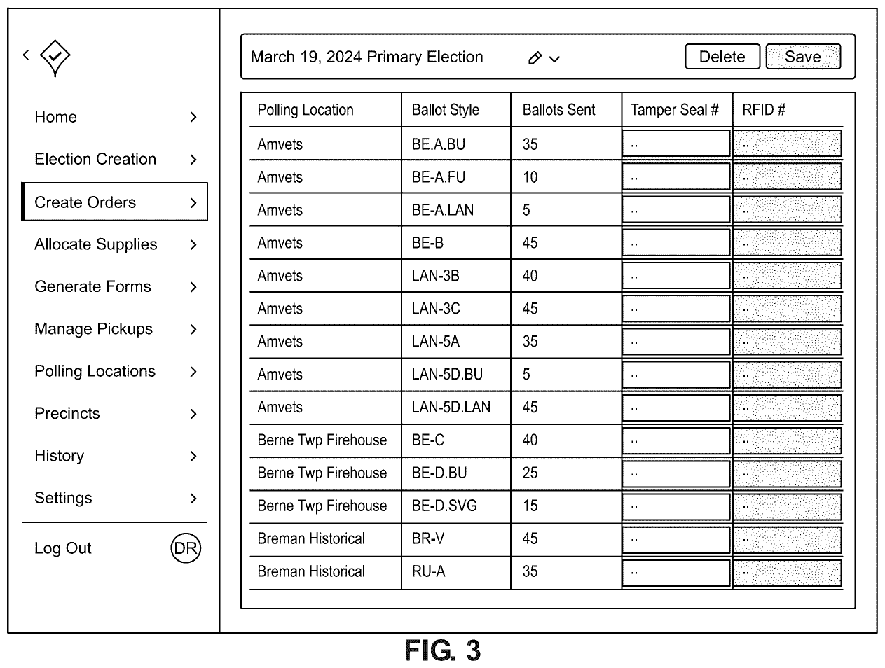

As shown in FIG. 3, a preferred embodiment of the interface for creation and management of ballot styles includes text fields configured to record a polling location, a ballot style for each polling location, a number of ballots to be sent to each polling location, a tamper seal ID number to be associated with each order to a polling location, and an RFID number to be associated with each order to a polling location. Each polling location entry automatically generates a draft ballot order with information corresponding to the values entered in the fields for the ballot style, quantity, tamper seal ID number, and RFID number. As fields are updated with valid values, the corresponding order will be updated with the corresponding information.

Referring now to FIGS. 18-20 simultaneously, said interface for creation, management, and association of polling locations consists of a series of text fields used to record the contact information of each polling location, to associate the location with an election, and to associate the location with a precinct. A preferred embodiment of this interface includes text fields for a user to input the name of the location, the complete legal address of the location, and the name and phone number of two contacts associated with the location.

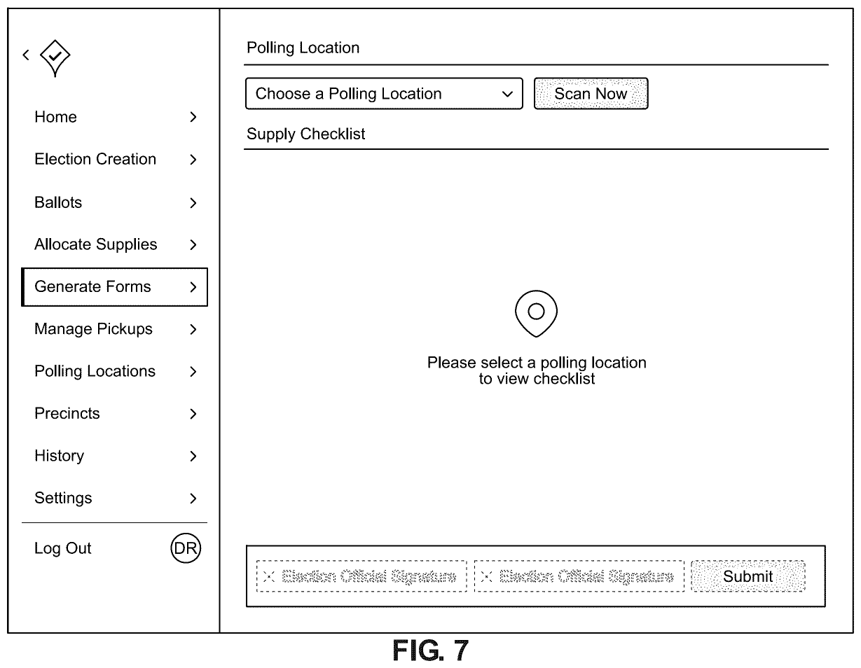

Referring now to FIGS. 7-17 simultaneously, said interface for management and association of supplies includes a supply checklist, a directory of polling locations, a list of approved orders to a selected polling location, and input fields for confirmation of received orders to a polling location. The polling location directory is automatically populated with each polling location entry. When a polling location is selected from the directory, the interface will display all ballot orders placed to that location. When an election jurisdiction receives a ballot order, they may scan the RFID tag on the ballot package. Scanning the ballot package RFID tag will transmit a signal to the application confirming that the ballot package associated with the scanned RFID tag has been received by the election jurisdiction. A preferred embodiment of this interface includes signature blocks for an oversight administrator and a second election official for double-verification that a ballot package has been successfully delivered.

Said interface for creation, management, and association of precincts consists of a series of text fields identical to those used to create, manage, and associate polling locations.

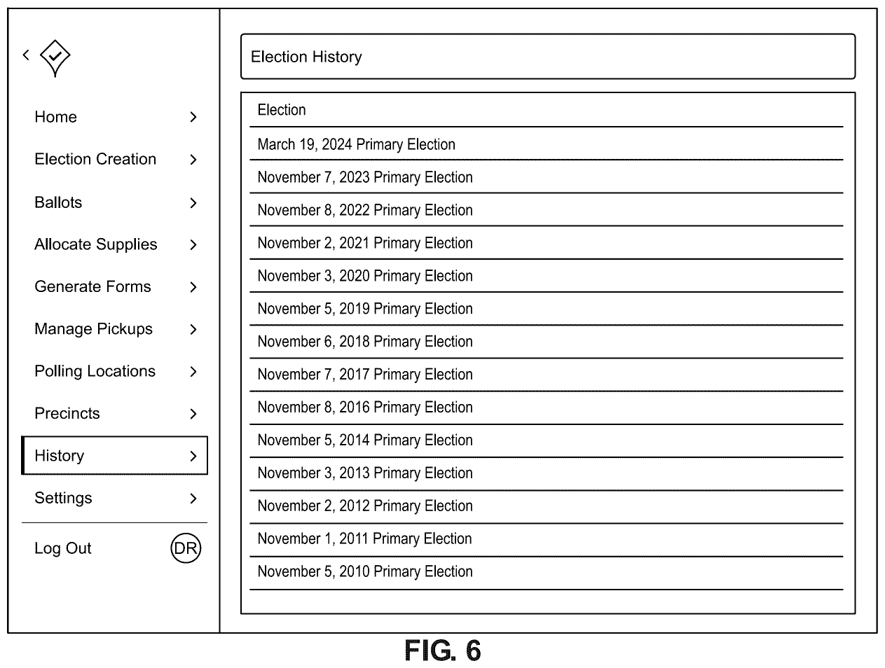

Referring now to FIG. 6, said interface to view the history and details of each election tracked by the application includes an entry of each action or record created by or tracked by the application. A preferred embodiment of this interface includes the ability for a user to sort entries by using various filters, such as date, name of election, polling location etc.

Said ballot paper is paper on which an election voter places a vote, as commonly known and understood in the prior art.

Said transport containers are affixed with a unique RFID tag, a unique tamper seal number, and are configured to store a plurality of ballot papers.

A preferred embodiment of the electronic means for electronically reading information is an RFID tag scanner, as commonly known in the prior art. The RFID tag scanner reads an RFID tag and records the event as an entry in the software application.

Said means for electronically transmitting information to the software application generally consists of configuring the electronic means of reading information to connect directly with the software application. A preferred embodiment of this is an RFID tag scanner that is directly connected to the software application.

To make the invention, one must become a licensed user of the software application. Once one is a licensed user, they can then log in to the application. A user may then navigate to the election creation interface and either manually input values into each available field or upload a CSV file with election-identifying information.

Once an election has been created and defined, a user may then navigate to the polling locations interface and input values into each field or upload a CSV file with polling location identifying information. A user will need to input the full, valid mailing address of each polling location to be used in an election. A user will also need to manually associate each polling location with a respective election by selecting a dropdown menu in this interface and selecting the respective election name.

Once polling locations have been created, a user may then create precincts by navigating to the precinct interface and following the same steps taken to create polling locations. A user will need to assign each precinct to a polling location via dropdown menus.

Once polling locations and precincts are created, a user may then navigate to the ballot style interface. The user may manually draft the ballot styles by utilizing the available fields in the interface, or alternatively the user may upload a CSV file with custom ballot paper to be replicated.

Once ballot styles are drafted, a user may continue using the ballot style interface and input the quantity of each ballot style to be sent to each polling location. When the user is satisfied with the amount of ballot papers allocated to each polling location, the user can confirm the orders.

Once ballot paper orders are confirmed, the order can be output and sent to a print vendor to fulfil the order, or used internally if the election jurisdiction prepares their ballots in-house. Once the ballots are delivered to or prepared by the election jurisdiction, they can begin repacking the ballots for their designated location.

Once a ballot transport container has been filled with all assigned ballot packages and sealed, the election official will scan the ballot transport container RFID tag to record the successful packing and sealing of the container. The container will then be transported via poll workers or election official staff to its assigned polling location.

Upon receipt of a ballot transport container by a polling location, an election official must scan the RFID tag of each ballot box. The election official will also inspect the tamper seal for any signs of tampering or attempts to unseal the ballot transport container. If any sign of tampering is noticed, the election official will report the incident to an oversight team. If no sign of tampering is found, a ballot transport container will be unsealed by a poll worker and the ballot packages will be organized and distributed at the polling location per industry standards.

An illustrative embodiment of the invention provides election officials the ability to track the repackaging of a ballot transport container. When election officials are ready to repack ballot transport container, the officials will scan the RFID tag of a ballot transport container to send a signal to the software application that each subsequent ballot package scanned by that RFID scanner will be assigned to the most recently scanned ballot transport container. Election officials will then scan each ballot package before placing the package into the most recently scanned ballot transport container.

When a ballot transport container has been filled to capacity with ballot packages, the ballot transport container will be rescaled with a tamper seal. The RFID tag of the ballot transport container will then be scanned prior to transportation, signaling to the software application that the ballot transport container is being transported to a central location for tabulation and storage of ballot votes.

Each central location will scan the RFID tag of each ballot transport container upon receipt, signaling to the software application that the ballot transport container has been received, prompting the user for signatures from the delivery and receiving teams.

Election officials at each central location will unpack ballot transport containers by first scanning the RFID tag of a ballot transport container, then breaking the tamper seal if no signs of tampering are noticed.

Each ballot paper order and RFID scan automatically generates an entry of the action in the software application's history interface.

I claim:

1. A system and method for improving the efficiency and security of election voting, generally comprising:
packages of ballot paper affixed with a unique, machine-readable identification tag;
ballot transport containers affixed with a unique, machine-readable identification tag;
a means for electronically reading a machine-readable identification tag;
a means for electronically transmitting information obtained from a machine-readable identification tag to a software application; and
a software application configured to receive and record the electronic transmission of information.

2. A system and method as in claim 1, wherein each package of ballot styles is electronically associated with a ballot transport container.

3. A system and method as in claim 1, wherein each ballot transport container is affixed with a tamper seal.

4. A system and method as in claim 1, wherein the machine-readable identification tags are RFID tags.

5. A system and method as in claim 1, wherein an RFID tag scanner comprises both the means for reading identification tags and the means for transmitting information from identification tags to the software application.

6. A system and method as in claim 1, wherein the software application maintains records of polling location information.

7. A system and method as in claim 1, wherein the software application maintains records of ballot styles and orders per polling location.

8. A system and method as in claim 1, wherein the software application automatically generates and stores an entry of every action taken on the application and every scan of an identification tag.

9. A system and method as in claim 1, wherein the software application automatically compiles pre and post transit information to form ballot chain-of-custody logs.

10. A system and method as in claim 1, wherein the software application includes an interface configured to draft ballot style quantities.

11. A system and method as in claim 1, wherein the software application includes an interface configured to view and manage shipments of election containers and ballot paper.

12. A system and method for improving the efficiency and security of election voting, generally comprising:
Packages of ballot paper affixed with a unique, machine-readable identification tag;
ballot transport containers affixed with a unique, machine-readable identification tag;
a means for electronically reading a machine-readable identification tag;
a means for electronically transmitting information obtained from a machine-readable identification tag to a software application; and
a software application configured to receive and record the electronic transmission of information;
said ballot paper packages being electronically associated with a ballot transport container;
said ballot transport containers being affixed with a tamper seal;
said machine-readable identification tags being RFID tags;
said means for reading identification tags and said means for transmitting information from identification tags to the software application being an RFID tag scanner;
said software application being configured to maintain records of polling location information;
said software application being configured to maintain records of ballot styles and orders per polling location;
said software application being configured to automatically generate and store an entry of every action taken on the application and every scan of an identification tag;
said software application being configured to automatically compile pre and post transit information to form ballot chain-of-custody logs;
said software application being configured to automatically compile pre and post transit information to form election material chain-of-custody forms;
said software application further comprising an interface configured to draft ballot style quantities;
said software application further comprising an interface configured to view and manage shipments of ballot boxes and ballot paper.
